(19) United States
(12) Patent Application Publication
(10) Pub. No.: US 2014/0310077 A1
(43) Pub. Date: Oct. 16, 2014

(54) COMPUTER IMPLEMENTED COALITION MARKETING PLATFORM AND A METHOD THEREOF

(71) Applicant: TELIBRAHMA CONVERGENT COMMUNICATIONS PRIVATE LIMITED, BANGALORE (IN)

(72) Inventor: SURESH NARASIMHA, BANGALORE (IN)

(73) Assignee: TELIBRAHMA CONVERGENT COMMUNICATIONS PRIVATE LIMITED, BNAGALORE (IN)

(21) Appl. No.: 14/249,059

(22) Filed: Apr. 9, 2014

(30) Foreign Application Priority Data
Apr. 11, 2013 (IN) 1641/CHE/2013

(51) Int. Cl. G06Q 50/00; G06Q 30/02

(52) U.S. Cl. CPC G06Q 50/01; G06Q 30/0229; G06Q 30/0255
USPC 705/14.3

(57) ABSTRACT

A computer implemented platform for creating a virtual community of sellers thereby enabling said sellers to jointly endorse the products and services, has been disclosed. The platform detects the presence of handheld devices of the users within a predetermined communication range, along with the coordinates. The platform presents to the users the location specific information corresponding to the products and service offered by the virtual community of sellers. The platform tracks the response of the user to the presented information along with the previous interactions of the users. The platform prompts each of the users to provide said platform with access at least their respective social networking profiles. The platform selectively customizes the information to be presented to the users thereby rendering the product/service offerings suitable for requirements of users, and forecasts the user requirements based on the tracked response information, and information corresponding to the previous interactions of users.

### CROSS-REFERENCE TO RELATED APPLICATION

The present application claims the priority of the Indian Provisional Patent Application No. 1641/CHE/2013 filed on 11 Apr., 2013 and having the title ‘method and system for providing digital coalition marketing’, the contents of which are incorporated herein by the way of reference.

### BACKGROUND

1. Technical Field

The present disclosure relates to the field of electronic commerce. Particularly, the present disclosure relates to the field of consumer centric marketing.

2. Description of Related Art

Typically products and services are marketed by sellers via advertisements. Typically, products and serviced on the print media and broadcast media including television and radio. The print media advertising also includes advertising on news papers, magazines, hoardings, digital signage and the like. Some of the other conventional marketing campaigns also include door-to-door campaigning/selling, conducting marketing campaigns at public gatherings, and the like. Further, another tacit form of marketing a product/service involves offering discounts/redeemable coupons on the said product/service.

With the advent of technology, the advertisers widened their marketing strategy to incorporate e-commerce and portals promoting/providing for online buying & selling of products/services. However, despite the phenomenal advancements in tele-marketing and online marketing, the consumer experience associated with online/tele marketing leaves a lot to be desired. Therefore, to enhance the consumer experience and also to enable consumers to extract better benefits and incentives in return for purchasing a particular product/service, there was felt a need for a system and method that would provide for generation of an umbrella/coalition of merchants/service providers, thereby enabling the consumers to avail incentives for shopping with any of the merchants under the umbrella. Further, there was also felt a need for a system & method that would enable the consumers to reap more benefits in exchange for engaging with any of the merchants under the umbrella. Further, there was also felt a need for a system & method that would assist merchants in effectively and efficiently marketing their products/services, by the way of forming an umbrella, which would promote all the affiliate products/services, in a customized manner as per the requirements of the consumers.

### OBJECTS OF THE EMBODIMENTS

An object of the present disclosure is to provide a system and method that would enable creation of an online coalition/umbrella involving a plurality of merchants/service providers.

Yet another object of the present disclosure is to provide a system and method that would provide consumers with greater benefits in exchange for shopping with any of the merchants of the coalition.

Still a further object of the present disclosure is to provide a system and method that would enable advertisers (merchants/service providers) to effectively market their products/services.

Another object of the present disclosure is to enable creation of a consortium/coalition of merchants, accessible to consumers via handheld devices.

Still a further object of the present disclosure is to provide an online marketing platform that generates customized marketing offers in response to the needs of the consumers.

One more object of the present disclosure is to provide an online marketing platform that enables user to avail offers/discounts depending upon their buying pattern, preferences and geographic location.

### SUMMARY

The present disclosure envisages a computer implemented platform accessible to a plurality of sellers, the platform configured to create a virtual community of sellers thereby enabling the sellers to jointly endorse the products and services. The platform is typically deployed on a communication network which is accessible to users via handheld devices.

In accordance with the present disclosure, the platform comprises a detecting module configured to detect the presence of handheld devices of the users within a predetermined communication range. The detecting module is further configured to determine the coordinates of the location of each of the users.

In accordance with the present disclosure, the platform comprises a presentation module configured to present to the users, at least the information corresponding to the products and service offered by the virtual community of sellers, the information being subjective to at least the location of the users and sellers of the virtual community, wherein the information includes at least offerings related information and discount related information.

In accordance with the present disclosure, the platform comprises a tracker configured to track at least the response of the user to the information presented by the presentation module. The tracker is further configured to track the previous interactions of the users with the platform. The tracker stores the response information provided by the users and the information corresponding to the previous interactions of users with the platform, in a repository.

In accordance with the present disclosure, the platform comprises a prompting module configured to prompt each of the users to provide the platform with access at least their respective social networking profiles. The platform further comprises an extractor configured to selectively extract at least the profile information, and the interaction history of the users from the corresponding social networking profiles.

In accordance with the present disclosure, the platform comprises a customizer cooperating with the tracker and extractor, the customizer further configured to selectively customize the information to be presented to the user, in order to render the product/service offerings suitable for specific requirements of the users. The customizer is further configured to forecast the requirements of the users based on at least the response information tracked by the tracker, information corresponding to the previous interactions users with the platform, the profile information and transaction history extracted by the extractor.

In accordance with the present disclosure, the platform is further configured to reward the users with at least predetermined number of credit points post the purchase of products/services offered by the virtual community of sellers. The platform is still further configured to selectively and automatically update the social networking profiles of the users with the information corresponding to the products/services purchased by the users through the virtual community.

In accordance with the present disclosure, the detecting module comprises a notification module, the notification module configured to notify the users of the availability of access to the virtual community of sellers via the communication network, the notification module further configured to notify the users to connect to the communication network via the handheld device(s).

In accordance with the present disclosure, the presentation module presents information selected from the group of information consisting of discounts related information, coupons availability information, customized offerings related information, gift vouchers related information, cash back related information product/service review related information, and location information of the sellers of the virtual community.

In accordance with the present disclosure, the presentation module provides information to the users in a format selected from the group consisting of pop-up advertisements, notifications, and short message service.

In accordance with the present disclosure, the repository is further configured to store the information including the information corresponding to the previous interactions of the users with the platform, information corresponding to the interactions of the users on the social networking platform, information corresponding to the purchases made by the users on the platform, information corresponding to the offerings provided by the sellers of the virtual community, and information corresponding to the social networking profiles of the users.

In accordance with the present disclosure, the tracker is further configured to track the previous interactions of the users with the platform, the tracker further configured to track at least the previous purchases made by users, previous recommendations generated by the users, previous discounts/gift coupons/cash back offers availed by the users, and purchase pattern of the users.

In accordance with the present disclosure, the computer implemented platform creates the virtual community by enabling a plurality of sellers to register themselves with the platform, combine their individual product/service offerings, the platform further configured to provide the users with access to the combined offerings.

The present disclosure envisages a computer implemented method for enabling a plurality of sellers to jointly endorse the products/services through a virtual community. The method, in accordance with the present disclosure comprises the following steps: deploying the virtual community on a communication network as a computer implemented platform, and providing for the communication network to be accessed by a plurality of users via handheld devices; detecting the presence of handheld devices of the users within a predetermined communication range, and determining the coordinates of the location of each of the users; presenting to the users, at least the information corresponding to the products and service offered by the virtual community of sellers, the information being subjective to at least the location of the users and sellers of the virtual community, wherein the information includes at least offerings related information and discount related information; tracking at least the response of the user to the presented information, and tracking the previous interactions of the users with the platform; storing in a repository, the response information provided by the users and the information corresponding to the previous interactions of users with the platform; prompting each of the users to provide the platform with access at least their respective social networking profiles; selectively extracting at least the profile information, and the interaction history of the users from the corresponding social networking profiles; forecasting the requirements of the users based on at least the response information tracked by the tracker, information corresponding to the previous interactions of users with the platform, the profile information and the extracted transaction history; selectively customizing the information to be presented to the user, in order to render the product/service offerings suitable for requirements of the users; rewarding the users with at least predetermined number of credit points post the purchase of products/services offered by the virtual community; and selectively and automatically update the social networking profiles of the users with the information corresponding to the products/services purchased by the users through the virtual community.

In accordance with the present disclosure, the step of detecting the presence of handheld devices of the users within a predetermined communication range further includes the step of notifying the users of the availability of access to the virtual community of sellers via the communication network, and notifying the users to connect to the communication network via the handheld device(s).

In accordance with the present disclosure, the step of presenting to the users, at least the information corresponding to the products and service offered by the virtual community of sellers, further includes the step of presenting information selected from the group of information consisting of discounts related information, coupons availability information, customized offerings related information, gift vouchers related information, cash back related information, product/service review related information, and location information of the sellers of the virtual community.

In accordance with the present disclosure, the step of presenting to the users, at least the information corresponding to the products and service offered by the virtual community of sellers, further includes the step of presenting the information to the users in format selected from the group consisting of pop-up advertisements, notifications, and short message service.

In accordance with the present disclosure, the step of storing in a repository, the response information provided by the users and the information corresponding to the previous interactions of users with the platform, further includes the step of storing in the repository the information corresponding to the previous interactions of the users with the platform, information corresponding to the interactions of the users on the social networking platform, information corresponding to the purchases made by the users on the platform, information corresponding to the offerings provided by the sellers of the virtual community, and information corresponding to the social networking profiles of the users.

In accordance with the present disclosure, the step of tracking at least the response of the user to the presented information, further includes the step of tracking the previous interactions of the users with the platform, and tracking at least the previous purchases made by users, previous recommendations generated by the users, previous discounts/gift coupons/cash back offers availed by the users, and purchase pattern of the users.

In accordance with the present disclosure, the method further includes the following steps: creating the virtual community by enabling a plurality of sellers to register themselves with the platform; and combining the individual product/service offerings of each of the sellers and providing the users with access to the combined offerings.

The present disclosure, in accordance with a third embodiment, envisages a non transitory computer readable medium having computer readable instructions stored thereupon, the computer readable instructions when executed by a processor are configured to cause a computer enabled device to: deploy the virtual community on a communication network as a computer implemented platform, and provide for the communication network to be accessed by a plurality of users via handheld devices; detect the presence of handheld devices of the users within a predetermined communication range, and determine the coordinates of the location of each of the users; present to the users, at least the information corresponding to the products and service offered by the virtual community of sellers, the information being subjective to at least the location of the users and sellers of the virtual community, wherein the information includes at least offerings related information and discount related information; track at least the response of the user to the presented information, and track the previous interactions of the users with the platform; store in a repository, the response information provided by the users and the information corresponding to the previous interactions of users with the platform; prompt each of the users to provide the platform with access at least their respective social networking profiles; selectively extract at least the profile information, and the interaction history of the users from the corresponding social networking profiles; forecast the requirements of the users based on at least the response information tracked by the tracker, information corresponding to the previous interactions of users with the platform, the profile information and the extracted transaction history; selectively customize the information to be presented to the user, in order to render the product/service offerings suitable for requirements of the users; reward the users with at least predetermined number of credit points post the purchase of products/services offered by the virtual community: and selectively and automatically update the social networking profiles of the users with the information corresponding to the products/services purchased by the users through the virtual community.

In accordance with the present disclosure, the computer readable instructions, when executed by a processor are further configured to enable a computer enabled device to: notify the users of the availability of access to the virtual community of sellers via the communication network, and notify the users to connect to the communication network via the handheld device(s); present the information selected from the group of information consisting of discounts related information, coupons availability information, customized offerings related information, gift vouchers related information, cash back related information, product/service review related information, and location information of the sellers of the virtual community; and present the information to the users in a format selected from the group consisting of pop-up advertisements, notifications, and short message service.

In accordance with the present disclosure, the computer readable instructions, when executed by a processor are further configured to enable a computer enabled device to: store in the repository the information corresponding to the previous interactions of the users with the platform, information corresponding to the interactions of the users on the social networking platform, information corresponding to the purchases made by the users on the platform, information corresponding to the offerings provided by the sellers of the virtual community, and information corresponding to the social networking profiles of the users; track the previous interactions of the users with the platform, and track at least the previous purchases made by users, previous recommendations generated by the users, previous discounts/gift coupons/cash back offers availed by the users, and purchase pattern of the users; create the virtual community by enabling a plurality of sellers to register themselves with the platform; and combine the individual product/service offerings of each of the sellers and providing the users with access to the combined offerings.

### BRIEF DESCRIPTION OF THE DRAWINGS

The other objects, features and advantages will occur to those skilled in the art from the description of the embodiments of the present disclosure and the accompanying drawings in which:

FIG. 1 illustrates a system level block diagram of a computer implemented coalition marketing, platform; and

FIG. 2 and FIG. 3 illustrate a flowchart comprising the steps involved in the method for implementing the coalition marketing platform.

### DETAILED DESCRIPTION OF THE EMBODIMENTS

On the outset, the present disclosure envisages a computer implemented platform for implementing coalition marketing, and a method for implementation of the platform. The platform envisaged by the present disclosure enables merchants to form a coalition/umbrella, and offer products/services and appropriate incentives for consumers, for shopping from the coalition/umbrella. Further, the platform also provides relevant information corresponding to the merchants, their products/services, typically via the handheld devices accessible to the consumers. Further, the platform enables merchants to customize the offers to be made available to the consumers, based on at least the location of the consumers, previous interactions of the consumers including the buying pattern of the consumers.

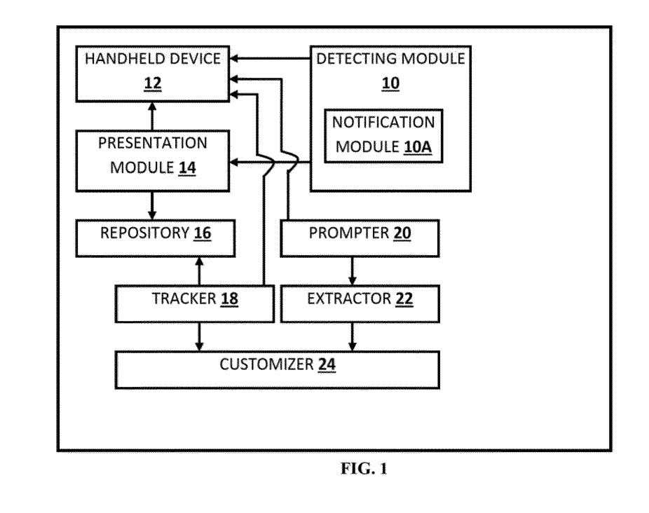

Referring to the accompanying drawings, FIG. 1 illustrates a system level block diagram corresponding to the coalition platform 100. The coalition platform 100, in accordance with the present disclosure is accessible to a plurality of sellers (typically merchants who market their products/services). The platform 100 enables the (plurality of) sellers to merge their individual activities under the coalition/umbrella, along with the merger of the marketing activities including promotion of products/services and selling of the same. The coalition platform 100 of the present disclosure can be construed as a virtual community of merchants and consumers.

The coalition platform 100 is deployed on the World Wide Web, and can be accessed by the consumers via a communication network such as a Wi-Fi network, ZigBee network. The platform 100 is typically accessed by consumers via handheld devices including but not restricted to mobile phone, laptop computer, Tablet PC and iPad.

The Platform 100, in accordance with the present disclosure comprises a detecting module 10 configured to cooperate with the communication network (not shown in figures) on which the platform 100 has been deployed. Further, the detecting module 10 detects the handheld devices 12 that are accessing (in communication with) the platform 100. Further, the detecting module 10 also determines, typically using a Global Positioning Device (not shown in figures), the coordinates of the location of each of the consumers (also referred to as users), who are accessing the platform 100, via their handheld devices 12. The platform 100 typically brings together the merchants who are within a predetermined range, for example 2 miles, and therefore, the detecting module also works under the limitation of the range of the platform. That is the range of the detecting module 10 will be the same as the range of the platform 100. The detecting module 10, therefore detect the presence of the handheld device and the coordinates of the specific location thereof only when a handled device 12 is with the predetermined range.

In accordance with the present disclosure, the platform 100 further comprises a presentation module 14. The presentation module 14 cooperates with the detection module 12, and is configured to present to the (detected) consumers, the information corresponding to products and services offered by the virtual community (platform) of merchants. The information provided to the detected consumers includes information corresponding to at least the offers and discounts provided by the merchants of the virtual community. The presentation module 14 cooperates with a repository 16, from which it retrieves the information corresponding to the products and services offered by the virtual community of merchants, and the information corresponding to the offers and discounts provided by the merchants of the virtual community. The presentation module 14 selects from repository 16, the information to be presented to each of the users of the platform 100. The selection by the presentation module 14 is based typically on the (determined) location of each of the consumers. That is, the selection is typically based on the distance between the determined location of each of the consumers, and the location of each of the merchants of the platform 100. Typically, the presentation module 14 presents consumers with the information corresponding to those merchants (of the platform 100) who are within a predetermined distance (for example, a mile). Typically, when a consumer enters a particular merchant's store (a merchant who is a part of the platform 100), the detecting module 10 could detect the presence of the handheld device 12 of the consumer, and the coordinates indicating the location of the handheld device of the consumer. Accordingly, the presentation module 14 receives the location related information corresponding to the consumer, from the detecting module 10, and subsequently searches the repository 16 for the information relevant to the consumer given the consumer's location. In this example, the consumer's location is determined to be a particular merchant's store, and therefore, the presentation module 14 extracts form the repository 16, only those bits of information that correspond to the particular merchant, and presents the same to the consumer, on his handheld device 12.

In accordance with the present disclosure, the platform 100 further comprises a tracker 18 configured to track the response of each of the consumers, to the information provided by the presentation module 14. The tracker 18 is configured to track the responses of the consumers including but not restricted to ‘liking the presented information’, ‘disliking the presented information’, ‘sharing the presented information’, referring the presented information to friend(s) and performing a shopping activity related to the presented information. The tracker 18 also tracks any of the previous interaction of the consumers (previous interaction including at least the aforementioned actions) with the platform 100. Typically, the information tracked by the tracker 18 is stored in the repository 16.

In accordance with the present discourse, the platform 100 further comprises a prompting module 20 configured to prompt each of the (detected) consumers to provide the platform 100 with access to their social networking profiles including but not restricted to Face book profile and LinkedIn Profile. If granted access to the social networking profile, the extractor 22 extracts the profile information, and the interaction history of the respective consumers, from the corresponding social networking profiles.

In accordance with the present disclosure, the platform 100 further comprises a customizer 22 configured to selectively customize the information to be presented to the consumers, in order to render the product/service offerings suitable for specific requirements of the consumers. The specific requirements of the consumers are determined based on the response information tracked by the tracker 18, information corresponding to the previous interactions of users with the platform 100, the profile information and transaction history extracted by the extractor 22.

In accordance with the present disclosure, the platform 100 is further configured to reward the users with at least predetermined number of credit points post the purchase of products/services offered by the virtual community of merchants/service providers. The platform 100 selectively and automatically updates the social networking profiles of the respective consumers with the information corresponding to the products/services purchased by the consumers through the virtual community.

In accordance with the present disclosure, the detecting module 10 comprises a notification module 10A. The notification module 10A is configured to notify the consumers of the availability of access to the virtual community of sellers (platform 100) via the communication network. The notification module is further configured to notify the consumers to connect to the communication network (deploying the platform 100) via the handheld device(s) 12.

In accordance with the present disclosure, the presentation module 14 presents information selected from the group of information consisting of discounts related information, coupons availability information, customized offerings related information, gift vouchers related information, cash back related information. product/service review related information, and location information of the sellers of the virtual community.

In accordance with the present disclosure, the presentation module 14 provides information to the users in a format selected from the group consisting of pop-up advertisements, notifications, and short message service. In accordance with the present disclosure, the repository 16 is further configured to store the information including the information corresponding to the previous interactions of the users with the platform, information corresponding to the interactions of the users on the social networking platform, information corresponding to the purchases made by the users on the platform, information corresponding to the offerings provided by the sellers of the virtual community, and information corresponding to the social networking profiles of the users.

In accordance with the present disclosure, the tracker 18 is further configured to track the previous interactions of the consumers with the platform 100, including the previous purchases made by consumers, previous recommendations generated by the consumers, previous discounts/gift coupons/cash back offers availed by the consumers, and purchase pattern of the consumers.

In accordance with the present disclosure, the computer implemented platform 100 creates the virtual community by enabling a plurality of merchants/service providers to register themselves with the platform, combine their individual product/service offerings, the platform 100 further configured to provide the consumers with access to the combined offerings.

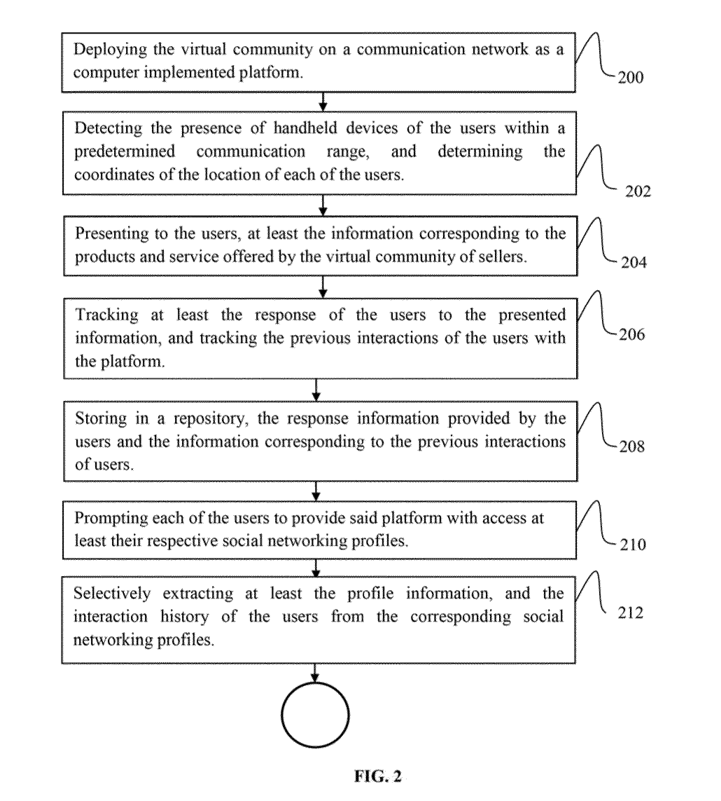

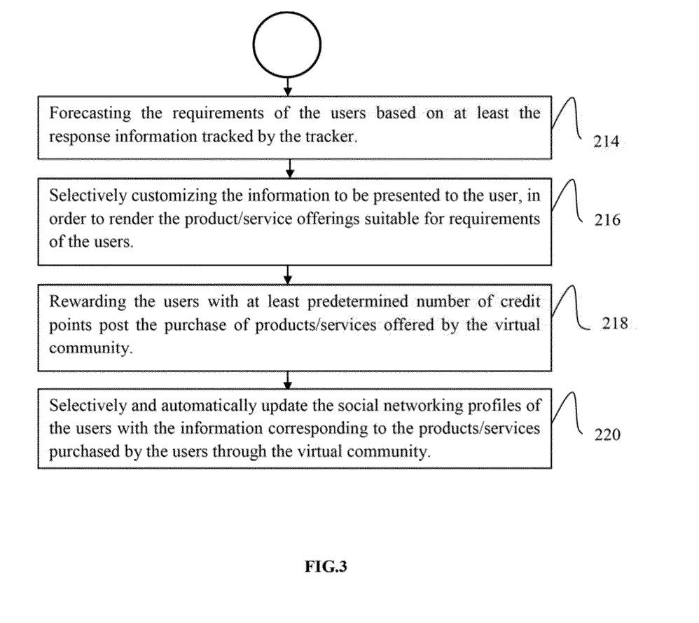

With reference to FIGS. 2 and FIG. 3, the present disclosure envisages a flowchart corresponding to the computer implemented method for enabling a plurality of sellers to jointly endorse the products/services through a virtual community. The method, in accordance with the present disclosure comprises the following steps: deploying the virtual community on a communication network as a computer implemented platform, and providing for the communication network to be accessed by a plurality of users via handheld devices 200; detecting the presence of handheld devices of the users within a predetermined communication range, and determining the coordinates of the location of each of the users; presenting to the users, at least the information corresponding to the products and service offered by the virtual community of sellers, the information being subjective to at least the location of the users and sellers of the virtual community, wherein the information includes at least offerings related information and discount related information 202; tracking at least the response of the user to the presented information, and tracking the previous interactions of the users with the platform 204; storing, in a repository, the response information provided by the users and the information corresponding to the previous interactions of users with the platform 206; prompting each of the users to provide the platform with access at least their respective social networking profiles 208; selectively extracting at least the profile information, and the interaction history of the users from the corresponding social networking profiles 210; forecasting the requirements of the users based on at least the response information tracked by the tracker, information corresponding to the previous interactions of users with the platform, the profile information and the extracted transaction history 212; selectively customizing the information to be presented to the user, in order to render the product/service offerings suitable for requirements of the users 214; rewarding the users with at least predetermined number of credit points post the purchase of products/services offered by the virtual community 216; and selectively and automatically update the social networking profiles of the users with the information corresponding to the products/services purchased by the users through the virtual community 218.

In accordance with the present disclosure, the step of detecting the presence of handheld devices of the users within a predetermined communication range further includes the step of notifying the users of the availability of access to the virtual community of sellers via the communication network, and notifying the users to connect to the communication network via the handheld device(s).

In accordance with the present disclosure, the step of presenting to the users, at least the information corresponding to the products and service offered by the virtual community of sellers, further includes the step of presenting information selected from the group of information consisting of discounts related information, coupons availability information, customized offerings related information, gift vouchers related information, cash back related information, product/service review related information, and location information of the sellers of the virtual community.

In accordance with the present disclosure, the step of presenting to the users, at least the information corresponding to the products and service offered by the virtual community of sellers, further includes the step of presenting the information to the users in a format selected from the group consisting of pop-up advertisements, notifications, and short message service.

In accordance with the present disclosure, the step of storing in a repository, the response information provided by the users and the information corresponding to the previous interactions of users with the platform, further includes the step of storing in the repository the information corresponding to the previous interactions of the users with the platform, information corresponding to the interactions of the users on the social networking platform, information corresponding to the purchases made by the users on the platform, information corresponding to the offerings provided by the sellers of the virtual community, and information corresponding to the social networking profiles of the users.

In accordance with the present disclosure, the step of tracking at least the response of the user to the presented information, further includes the step of tracking the previous interactions of the users with the platform, and tracking at least the previous purchases made by users, previous recommendations generated by the users, previous discounts/gift coupons/cash back offers availed by the users, and purchase pattern of the users.

In accordance with the present disclosure, the method further includes the following steps: creating the virtual community by enabling a plurality of sellers to register themselves with the platform; and combining the individual product/service offerings of each of the sellers and providing the users with access to the combined offerings.

The present disclosure, further envisages a non transitory computer readable medium having computer readable instructions stored thereupon, the computer readable instructions when executed by a processor are configured to cause a computer enabled device to: deploy the virtual community on a communication network as a computer implemented platform, and provide for the communication network to be accessed by a plurality of users via handheld devices; detect the presence of handheld devices of the users within predetermined communication range, and determine the coordinates of the location of each of the users; present to the users, at least the information corresponding to the products and service offered by the virtual community of sellers, the information being subjective to at least the location of the users and sellers of the virtual community, wherein the information includes at least offerings related information and discount related information; track at least the response of the user to the presented information, and track the previous interactions of the users with the platform; store in a repository, the response information provided by the users and the information corresponding to the previous interactions of users with the platform; prompt each of the users to provide the platform with access at least their respective social networking profiles; selectively extract at least the profile information, and the interaction history of the users from the corresponding social networking profiles; forecast the requirements of the users based on at least the response information tracked by the tracker, information corresponding to the previous interactions of users with the platform, the profile information and the extracted transaction history; selectively customize the information to be presented to the user, in order to render the product/service offerings suitable for requirements of the users; reward the users with at least predetermined number of credit points post the purchase of products/services offered by the virtual community; and selectively and automatically update the social networking profiles of the users with the information corresponding to the products/services purchased by the users through the virtual community.

In accordance with the present disclosure, the computer readable instructions, when executed by a processor are further configured to enable a computer enabled device to: notify the users of the availability of access to the virtual community of sellers via the communication network, and notify the users to connect to the communication network via the handheld device(s); present the information selected from the group of information consisting of discounts related information, coupons availability information, customized offerings related information, gift vouchers related information, cash back related information, product/service review related information, and location information of the sellers of the virtual community; and present the information to the users in a format selected from the group consisting of pop-up advertisements, notifications, and short message service.

In accordance with the present disclosure, the computer readable instructions, when executed by a processor are further configured to enable a computer enabled device to: store in the repository the information corresponding to the previous interactions of the users with the platform, information corresponding to the interactions of the users on the social networking platform, information corresponding to the purchases made by the users on the platform, information corresponding to the offerings provided by the sellers of the virtual community, and information corresponding to the social networking profiles of the users; track the previous interactions of the users with the platform, and track at least the previous purchases made by users, previous recommendations generated by the users, previous discounts/gift coupons/cash back offers availed by the users, and purchase pattern of the users; create the virtual community by enabling a plurality of sellers to register themselves with the platform; and combine the individual product/service offerings of each of the sellers and providing the users with access to the combined offerings.

### TECHNICAL ADVANTAGES

The technical advantages of the present disclosure include the realization of a system and method that would enable creation of an online coalition/umbrella involving a plurality of merchants/service providers. The system and method would provide consumers with greater benefits in exchange for shopping with any of the merchants of the coalition. The system and method enables advertisers (merchants/service providers) to effectively market their products/services. The system of the present disclosure enables creation of a consortium/coalition of merchants, accessible to consumers via handheld devices. The present disclosure also envisages an online marketing platform that generates customized marketing offers in response to the needs of the consumers. The online marketing platform also enables user to avail offers/discounts depending upon their buying pattern, preferences and geographic location.

1. A computer implemented platform accessible to a plurality of sellers, said platform configured to create a virtual community of sellers thereby enabling said sellers to jointly endorse the products and services, said platform deployed on a communication network, the communication network accessible to users via handheld devices, said platform comprising:
a detecting module configured to detect the presence of handheld devices of the users within a predetermined communication range, said detecting module further configured to determine the coordinates of the location of each of the users;
a presentation module configured to present to the users, at least the information corresponding to the products and service offered by the virtual community of sellers, said information being subjective to at least the location of the users and sellers of the virtual community, wherein said information includes at least offerings related information and discount related information;
a tracker configured to track at least the response of the users to the information presented by said presentation module, said tracker further configured to track the previous interactions of the users with the platform, said tracker still further configured to store the response information provided by the users and the information corresponding to the previous interactions of users with the platform, in a repository;
a prompting module configured to prompt each of the users to provide said platform with access at least their respective social networking profiles;
an extractor configured to selectively extract at least the profile information, and the interaction history of the users from the corresponding social networking profiles;
a customizer cooperating with the tracker and extractor, said customizer further configured to selectively customize the information to be presented to users, in order to render the product/service offerings suitable for specific requirements of the users, said customizer configured to forecast the requirements of the users based on at least the response information tracked by the tracker, information corresponding to the previous interactions of users with the platform, the profile information and transaction history extracted by the extractor;
said platform further configured to reward the users with at least predetermined number of credit points post the purchase of products/services offered by the virtual community of sellers, said platform still further configured to selectively and automatically update the social networking profiles of the users with the information corresponding to the products/services purchased by the users through the virtual community.

2. The computer implemented platform as claimed in claim 1, wherein said detecting module comprises a notification module, said notification module configured to notify the users of the availability of access to the virtual community of sellers via the communication network, said notification module thriller configured to notify the users to connect to the communication network via the handheld device(s).

3. The computer implemented platform as claimed in claim 1, wherein the presentation module presents information selected from the group of information consisting of discounts related information, coupons availability information, customized offerings related information, gift vouchers related information, cash back related information, product/service review related information, and location information of the sellers of the virtual community.

4. The computer implemented platform as claimed in claim 3, wherein the presentation module provides information to the users in a format selected from the group consisting of pop-up advertisements, notifications, and short message service.

5. The computer implemented platform as claimed in claim 1, wherein the repository is further configured to store the information including the information corresponding to the previous interactions of the users with the platform, information corresponding to the interactions of the users on the social networking platform, information corresponding to the purchases made by the users on the platform, information corresponding to the offerings provided by the sellers of the virtual community, and information corresponding to the social networking profiles of the users.

6. The computer implemented platform as claimed in claim 1, wherein said tracker is further configured to track the previous interactions of the users with the platform, said tracker further configured to track at least the previous purchases made by users, previous recommendations generated by the users, previous discounts/gift coupons/cash back offers availed by the users, and purchase pattern of the users.

7. The computer implemented platform as claimed in claim 1, wherein said computer implemented platform creates the virtual community by enabling a plurality of sellers to register themselves with the platform, combine their individual product/service offerings, said platform further configured to provide the users with access to the combined offerings.

8. A computer implemented method for enabling, a plurality of sellers to jointly endorse the products/services through a virtual community, said method comprising the following steps:
deploying the virtual community on a communication network as a computer implemented platform, and providing for the communication network to be accessed by a plurality of users via handheld devices;
detecting the presence of handheld devices of the users within a predetermined communication range, and determining the coordinates of the location of each of the users;
to presenting to the users, at least the information corresponding to the products and service offered by the virtual community of sellers, said information being subjective to at least the location of the users and sellers of the virtual community, wherein said information includes at least offerings related information and discount related information;
tracking at least the response of the users to the presented information, and tracking the previous interactions of the users with the platform;
storing in a repository, the response information provided by the users and the information corresponding to the previous interactions of users with the platform;
prompting each of the users to provide said platform with access at least their respective social networking profiles;
selectively extracting at least the profile information, and the interaction history of the users from the corresponding social networking profiles;
forecasting the requirements of the users based on at least the response information tracked by the tracker, information corresponding to the previous interactions of users with the platform, the profile information and the extracted transaction history;
selectively customizing the information to be presented to the user, in order to render the product/service offerings suitable for requirements of the users;
rewarding the users with at least predetermined number of credit points post the purchase of products/services offered by the virtual community; and
to selectively and automatically update the social networking profiles of the users with the information corresponding to the products/services purchased by the users through the virtual community.

9. The computer implemented method as claimed in claim 8, wherein the step of detecting the presence of handheld devices of the users within a predetermined communication range further includes the step of notifying the users of the availability of access to the virtual community of sellers via the communication network, and notifying the users to connect to the communication network via the handheld device(s).

10. The computer implemented method as claimed in claim 8, wherein the step of presenting to the users, at least the information corresponding to the products and service offered by the virtual community of sellers, further includes the step of presenting information selected from the group of information consisting of discounts related information, coupons availability information, customized offerings related information, gift vouchers related information, cash back related information, product/service review related information, and location information of the sellers of the virtual community.

11. The computer implemented method as claimed in claim 8, wherein the step of presenting to the users, at least the information corresponding to the products and service offered by the virtual community of sellers, further includes the step of presenting the information to the users in a format selected from the group consisting of pop-up advertisements, notifications, and short message service.

12. The computer implemented method as claimed in claim 8, wherein the step of storing in a repository, the response information provided by the users and the information corresponding to the previous interactions of users with the platform, further includes the step of storing in the repository the information corresponding to the previous interactions of the users with the platform, information corresponding to the interactions of the users on the social networking platform, information corresponding to the purchases made by the users on the platform, information corresponding to the offerings provided by the sellers of the virtual community, and information corresponding to the social networking profiles of the users.

13. The computer implemented method as claimed in claim 8, wherein the step of tracking at least the response of the user to the presented information, further includes the step of tracking the previous interactions of the users with the platform, and tracking at least the previous purchases made by users, previous recommendations generated by the users, previous discounts/gift coupons/cash back offers availed by the users, and purchase pattern of the users.

14. The computer implemented method as claimed in claim 8, wherein the method further includes the following steps:
creating the virtual community by enabling a plurality of sellers to register themselves with the platform; and
combining the individual product/service offerings of each of the sellers and providing the users with access to the combined offerings.

15. A non transitory computer readable medium having computer readable instructions stored thereupon, said computer readable instructions when executed by a processor, are configured to cause a computer enabled device to:
deploy the virtual community on a communication network as a computer implemented platform, and provide for the communication network to be accessed by a plurality of users via handheld devices;
detect the presence of handheld devices of the users within a predetermined communication range, and determine the coordinates of the location of each of the users;
present to the users, at least the information corresponding to the products and service offered by the virtual community of sellers, said information being subjective to at least the location of the users and sellers of the virtual community, wherein said information includes at least offerings related information and discount related information;
track at least the response of the user to the presented information, and track the previous interactions of the users with said platform;
store in a repository, the response information provided by the users and the information corresponding to the previous interactions of users with the platform;
prompt each of the users to provide said platform with access at least their respective social networking profiles;
selectively extract at least the profile information, and the interaction history of the users from the corresponding social networking profiles;
forecast the requirements of the users based on at least the response information tracked by the tracker, information corresponding to the previous interactions of users with the platform, the profile information and the extracted transaction history;
selectively customize the information to be presented to the user, in order to render the product/service offerings suitable for requirements of the users;
to reward the users with at least predetermined number of credit points post the purchase of products/services offered by the virtual community; and
selectively and automatically update the social networking profiles of the users with the information corresponding to the products/services purchased by the users through the virtual community.

16. The non transitory computer readable medium as claimed in claim 15, wherein the computer readable instructions, when executed by a processor are further configured to enable a computer enabled. device to:
notify the users of the availability of access to the virtual community of sellers via the communication network, and notify the users to connect to the communication network via the handheld device(s);
present the information selected from the group of information consisting of discounts related information, coupons availability information, customized offerings related information, gift vouchers related information, cash back related information, product/service review related information, and location information of the sellers of the virtual community; and
present the information to the users in a format selected from the group consisting of pop-up advertisements, notifications, and short message service.

17. The non transitory computer readable medium as claimed in claim 15, wherein the computer readable instructions, when executed by a processor are further configured to enable a computer enabled device to:
store in the repository the information corresponding to the previous interactions of the users with the platform, information corresponding to the interactions of the users on the social networking platform, information corresponding to the purchases made by the users on the platform, information corresponding to the offerings provided by the sellers of the virtual community, and information corresponding to the social networking profiles of the users;
track the previous interactions of the users with the platform, and track at least the previous purchases made by users, previous recommendations generated by the users, previous discounts/gift coupons/cash back offers availed by the users, and purchase pattern of the users;
create the virtual community by enabling a plurality of sellers to register themselves with the platform; and
combine the individual product/service offerings of each of the sellers and providing the users with access to the combined offerings.
